(19) United States
(12) Patent Application Publication
(10) Pub. No.: US 2025/0378107 A1
(43) Pub. Date: Dec. 11, 2025

(54) PARALLEL OR SIMULTANEOUS INSERTS AND UPDATES TO A SINGLE PROXIMITY GRAPH

(71) Applicants: Ashish Krishnadeo Shinde, bangalore (IN); Tejas Sampige Prabhakara, bangalore (IN); Abhilash Bhanukant Mandaliy, vadodara (IN); Srinivasan Seshadri, scotts valley, CA (US); Balakrishnan Narendran, warren, NJ (US); Joseph Joaquin Martin, san francisco, CA (US); Adam David Hevenor, denver, CO (US)

(72) Inventors: Ashish Krishnadeo Shinde, bangalore (IN); Tejas Sampige Prabhakara, bangalore (IN); Abhilash Bhanukant Mandaliy, vadodara (IN); Srinivasan Seshadri, scotts valley, CA (US); Balakrishnan Narendran, warren, NJ (US); Joseph Joaquin Martin, san francisco, CA (US); Adam David Hevenor, denver, CO (US)

(21) Appl. No.: 19/050,090

(22) Filed: Feb. 10, 2025

Related U.S. Application Data
(60) Provisional application No. 63/551,537, filed on Feb. 9, 2024.

(51) Int. Cl. G06F 16/36; G06F 16/901

(52) U.S. Cl. CPC G06F 16/367; G06F 16/9024

(57) ABSTRACT

In one aspect, a method for parallel processing of updates to a proximity graph begins with providing a distributed system that comprises a plurality of proximus nodes. The method then proceeds with receiving an update request for the proximity graph at a selected proximus node from the plurality of proximus nodes. At the selected proximus node, the method involves maintaining a batch of updates in a local graph. The process continues with creating a batch graph comprising accumulated updates at each proximus node of the plurality of proximus nodes. Following this, a coordinator node merges the batch graph with a main graph to implement the updates. Finally, the method concludes by making the merged updates available for querying.

### CLAIM OF PRIORITY

This application claims priority to U.S. Provisional Patent Application No. 63/551,537, filed on Feb. 9, 2024. This application is incorporated by reference in its entirety.

### BACKGROUND

Vector similarity search has become increasingly important in modern computing applications, particularly in the context of machine learning, artificial intelligence, and large-scale data processing. Hierarchical Navigable Small World (HNSW) graphs have emerged as a powerful indexing structure for implementing efficient vector similarity searches, where vertices are linked based on their proximity using specified distance metrics. These proximity graphs enable the expression of complex relationships and support fast, approximate nearest neighbor search operations.

Traditional implementations of HNSW and other proximity graphs face significant challenges when handling concurrent operations, particularly in distributed systems. The primary limitation stems from the inherent difficulty of performing parallel or simultaneous updates to a single proximity graph while maintaining the graph's structural integrity and search quality. Current approaches typically require sequential processing of updates, creating a bottleneck that limits throughput and scalability in high-volume applications.

Several existing solutions attempt to address these challenges through various mechanisms. One common approach involves implementing strict locking mechanisms to ensure graph consistency during updates. However, this approach significantly impacts performance by serializing operations that could potentially be executed in parallel. Another approach utilizes multiple independent graphs that are periodically merged, but this leads to increased memory overhead and complexity in maintaining consistency across the system.

Furthermore, existing systems struggle with the trade-off between update speed and search quality. Fast updates often come at the cost of degraded search accuracy, while maintaining high search quality typically requires more time-consuming update procedures. This trade-off becomes particularly problematic in applications requiring both high throughput and high accuracy, such as real-time recommendation systems or large-scale similarity search services.

Distributed systems face additional challenges when implementing proximity graphs. The need to maintain consistency across multiple nodes while allowing for efficient parallel operations has led to complex architectures that are difficult to maintain and scale. Current solutions often require significant coordination overhead between nodes, limiting the potential performance benefits of distributed processing.

The optimization of proximity graphs in distributed environments presents another significant challenge. As graphs grow larger and more complex, the cost of maintaining optimal neighborhood relationships increases substantially. Background optimization processes, while necessary for maintaining search quality, can interfere with ongoing operations and impact system performance.

These limitations have become increasingly problematic as applications requiring vector similarity search continue to grow in scale and complexity. There is a pressing need for improved methods of handling parallel or simultaneous updates to proximity graphs, particularly in distributed environments where high throughput and scalability are essential requirements.

The present invention addresses these challenges by providing a novel approach to parallel and simultaneous updates in proximity graphs, specifically focusing on HNSW implementations. The invention enables efficient concurrent operations while maintaining search quality and system performance, representing a significant advancement in the field of vector similarity search.

### BRIEF SUMMARY OF THE INVENTION

In one aspect, a method for parallel processing of updates to a proximity graph begins with providing a distributed system that comprises a plurality of proximus nodes. The method then proceeds with receiving an update request for the proximity graph at a selected proximus node from the plurality of proximus nodes. At the selected proximus node, the method involves maintaining a batch of updates in a local graph. The process continues with creating a batch graph comprising accumulated updates at each proximus node of the plurality of proximus nodes. Following this, a coordinator node merges the batch graph with a main graph to implement the updates. Finally, the method concludes by making the merged updates available for querying.

### BRIEF DESCRIPTION OF THE DRAWINGS

FIG. 1 illustrates an example process for parallel or simultaneous inserts and updates to a single proximity graph, according to some embodiments.

FIG. 2 illustrates an example process for using proximus nodes to update the Hierarchical Navigable Small Worlds (HNSW) graph or an incoming vector, according to some embodiments.

FIG. 3 illustrates an example process for proximus node operation, according to some embodiments.

FIG. 4 illustrates an example process for implementing batch merging operations with proximus nodes, according to some embodiments.

FIG. 5 illustrates an example process of a merge algorithm, according to some embodiments.

FIG. 6 illustrates an example process for optimizing a main graph, according to some embodiments.

The Figures described above are a representative set and are not exhaustive with respect to embodying the invention.

### DESCRIPTION

Disclosed are a system, method, and article of manufacture for parallel or simultaneous inserts and updates to a single proximity graph, according to some embodiments.

The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Database schema is the structure of a database described in a formal language (e.g. supported by a relational database management system (RDBMS)). Schema refers to the organization of data as a blueprint of how the database is constructed (e.g. divided into database tables in the case of relational databases). A database schema can be a set of formulas (e.g. sentences) called integrity constraints imposed on a database. These integrity constraints ensure compatibility between parts of the schema.

Distributed database can be a database in which data is stored across different physical locations. In some example, the distributed database can be stored in multiple computers located in the same physical location such as a data center and/or maybe dispersed over a network of interconnected computers.

Graph is an abstract data type that is meant to implement the undirected graph and directed graph concepts from the field of graph theory within mathematics. A graph data structure consists of a finite set of vertices (e.g. nodes, points, etc.), together with a set of unordered pairs of these vertices for an undirected graph or a set of ordered pairs for a directed graph. These pairs are known as edges (e.g. links, lines, etc.), and for a directed graph are also known as edges but also sometimes arrows or arcs. The vertices may be part of the graph structure or may be external entities represented by integer indices or references. A graph data structure may also associate to each edge some edge value, such as a symbolic label or a numeric attribute (e.g. cost, capacity, length, etc.).

Hierarchical Navigable Small World (HNSW) graphs can be indexes for implementing vector similarity searches. An HNSW can be a proximity graph where two vertices are linked based on their proximity (e.g. the closer vertices can be linked based on a specified type of distance, etc.)

Proximity graph can be a graph with a distance metric defined for vertices. Proximity graphs enable the expression of complex proximity relationships and for use by other algorithms.

Similarity search can include a range of methods for searching spaces of objects using the comparator of the similarity between any pair of objects.

Vector search can use numeric representations (e.g. in lieu of plain text, etc.) of various content for search of information. Accordingly, a search can then match the vectors using a similarity score for the query and avoid a requirement for matching on exact terms.

### EXAMPLE METHODS

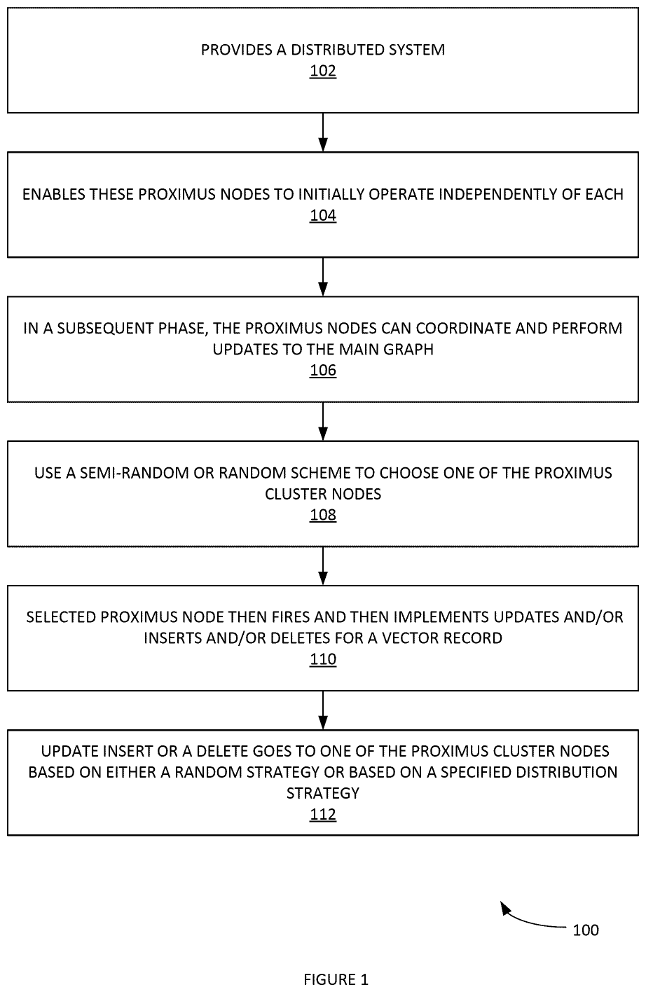

FIG. 1 illustrates an example process for parallel or simultaneous inserts and updates to a single proximity graph, according to some embodiments. Process 100 can be implemented in a distributed system such as Proximus. Process 100 can provide a mechanism of doing parallel or simultaneous inserts and updates to a single proximity graph specifically the hierarchical navigable small world graphs. Accordingly, a goal of this particular approach is to enable parallel inserts and parallel updates to small world graphs.

In step 102, process 100 provides a distributed system. This can be a distributed database such as a NoSQL database, etc. This can be a distributed system of vector search nodes (e.g. proximus nodes, etc.).

In step 104, process 100 enables these proximus nodes to initially operate independently of each. In step 106, in a subsequent phase, the proximus nodes can coordinate and perform updates to the main graph.

In step 108, process 100 can use a semi-random or random scheme to choose one of the proximus cluster nodes. In step 110, the selected proximus node then fires and then implements updates and/or inserts and/or deletes for a vector record.

The update insert or a delete goes to one of the proximus cluster nodes based on either a random strategy or based on a specified distribution strategy in step 112.

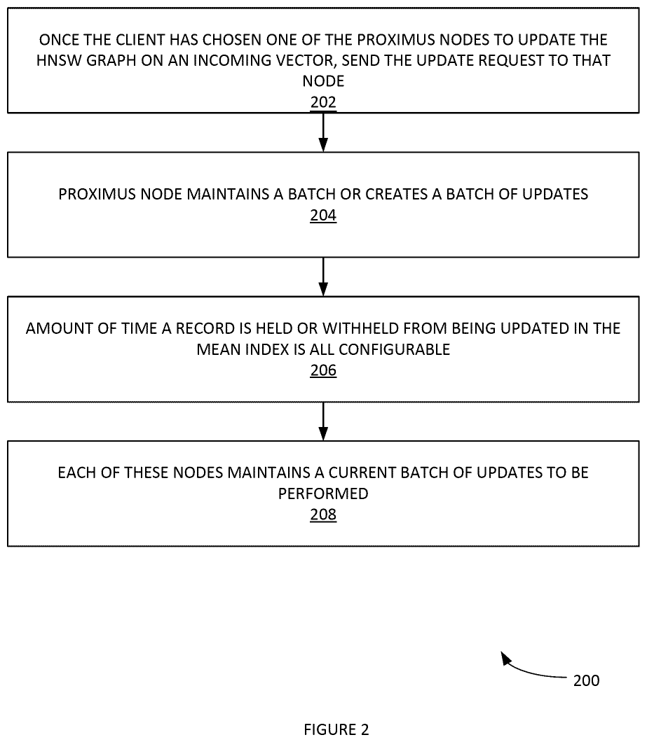

FIG. 2 illustrates an example process 200 for using proximus nodes to update the Hierarchical Navigable Small Worlds (HNSW) graph or an incoming vector, according to some embodiments. Once the client has chosen one of the proximus nodes to update the HNSW graph on an incoming vector, process 200 sends the update request to that node in step 202. In step 204, the proximus node maintains a batch or creates a batch of updates. The amount of time a record is held or withheld from being updated in the main index is all configurable in step 206. In step 208, each of these nodes maintains a current batch of updates to be performed.

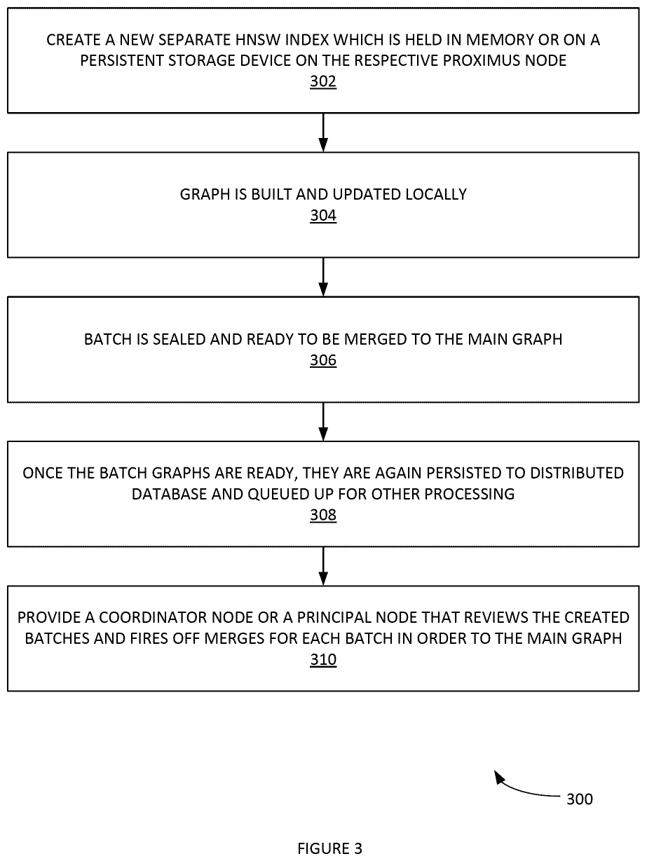

FIG. 3 illustrates an example process 300 for proximus node operation, according to some embodiments. Process 300 can be performed in a particular case for every batch. In step 302, process 300 creates a new separate HNSW index which is held in memory or on a persistent storage device on the respective proximus node. In step 304, the graph is built and updated locally (e.g. is not the original or the global graph).

Once each proximus node has a large enough set of updates accumulated in its own version of the main graph, the batch is sealed and ready to be merged to the main graph in step 306. In this way, each of the proximus nodes creates a plurality of batch graphs for their own set of updates and maintains them locally.

Once the batch graphs are ready, they are again persisted to a distributed database (e.g. an Aerospike™ database system, etc.) and queued up for other processing in step 308. In step 310, process 300 provide a coordinator node or a principal node that reviews the created batches and fires off merges for each batch in order to the main graph.

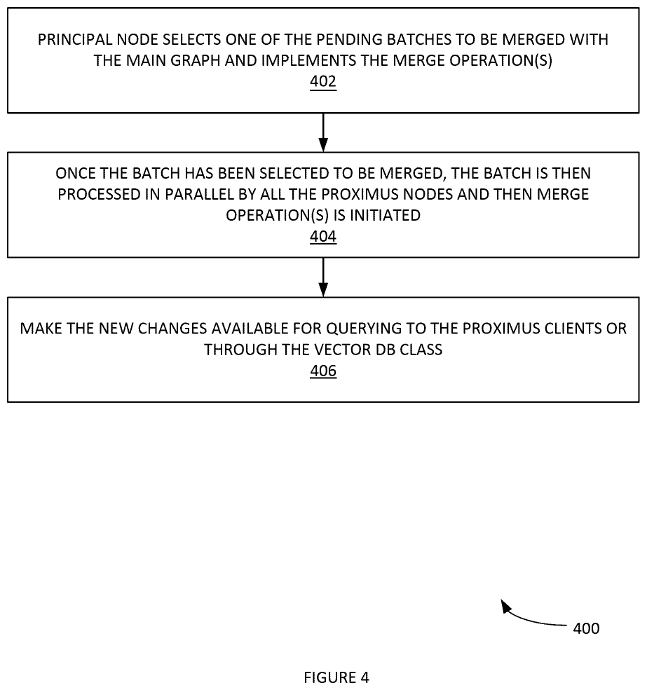

FIG. 4 illustrates an example process 400 for implementing batch merging operations with proximus nodes, according to some embodiments. In step 402, the principal node selects one of the pending batches to be merged with the main graph and implements the merge operation(s). Once the batch has been selected to be merged, the batch is then processed in parallel by all the proximus nodes and then merge operation(s) is initiated in step 404.

The merge operation includes a smaller subgraph of batched updates to be merged with the main graph for visibility in the final search. In step 406, process 400 makes the new changes available for querying to the proximus clients or through the vector DB class.

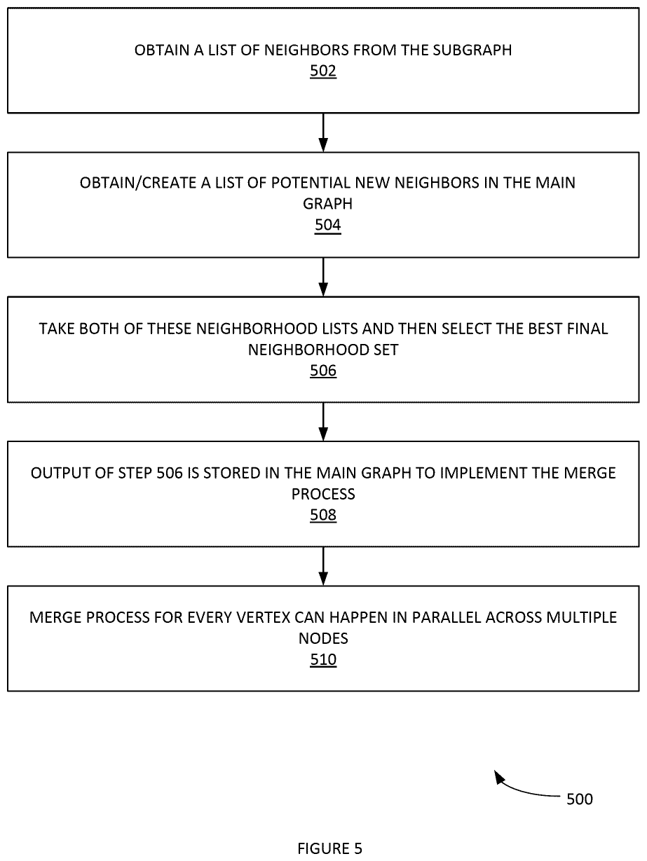

FIG. 5 illustrates an example process 500 of a merge algorithm, according to some embodiments. In step 502, process 500 obtains a list of neighbors from the subgraph. In step 504, process 500 obtains/creates a list of potential new neighbors in the main graph.

In step 506, process 500 takes both of these neighborhood lists and then select the best final neighborhood set. In step 508, output of step 506 is stored in the main graph to implement the merge process.

In this way, the merge process include the selection of the vertices of the neighbors of the smaller graph. There can be a determination of the potential neighbors for this vertex from the main graph. Process 500 can then merge these two neighborhood lists and then implement a selection and take the best neighbors. These are neighbors that process 500 stores in the main graph.

This merge process for every vertex can happen in parallel across multiple nodes in step 510. Process 500 does not significantly impact the quality of the search. Accordingly, process 500 (and the other processes provided herein) can enable parallel updates to HNSW or a proximity graph.

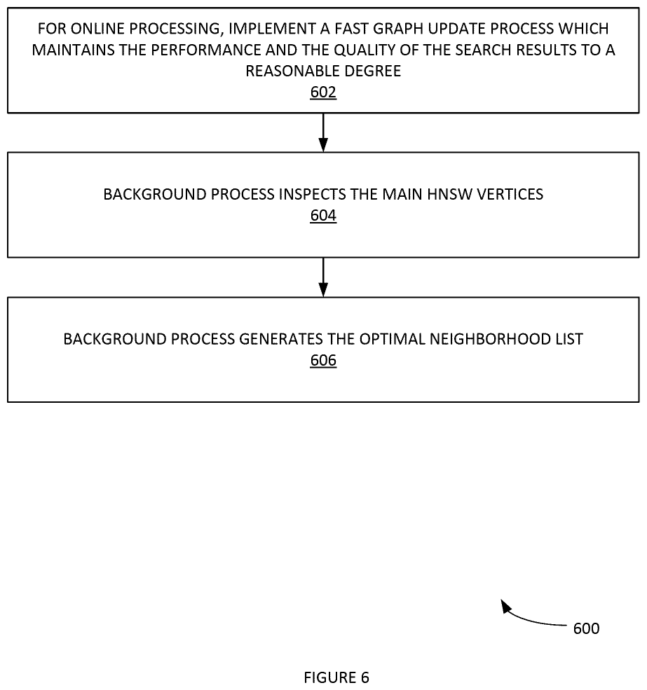

FIG. 6 illustrates an example process 600 for optimizing a main graph, according to some embodiments. In step 602, process 600, for online processing, implements a fast graph update process which maintains the performance and the quality of the search results to a reasonable degree. The background process periodically reviews the main graph and places it in the optimal form. Step 602 can be a continuously run process.

Periodically, a background process is kicked off and process 600 then proceeds to steps 604 and 606. In step 604, a background process inspects the main HNSW vertices. In step 606, the background process generates the optimal neighborhood list.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for parallel processing of updates to a proximity graph, comprising:
providing a distributed system comprising a plurality of proximus nodes;
receiving, at a selected proximus node from the plurality of proximus nodes, an update request for the proximity graph;
maintaining, at the selected proximus node, a batch of updates in a local graph;
creating, at each proximus node of the plurality of proximus nodes, a batch graph comprising accumulated updates;
merging, by a coordinator node, the batch graph with a main graph to implement the updates; and
providing the merged updates available for querying.

2. The method of claim 1, wherein selecting the proximus node comprises:
implementing a semi-random or random scheme to choose one of the plurality of proximus nodes and directing the update request to the chosen proximus node.

3. The method of claim 2, wherein maintaining the batch of updates comprises:
creating a separate Hierarchical Navigable Small World (HNSW) index in memory or persistent storage;
building and updating the local graph independently from the main graph; and
sealing the batch when a predetermined threshold of updates is accumulated.

4. The method of claim 3, wherein merging the batch graph comprises:
obtaining a list of neighbors from the batch graph;
creating a list of potential new neighbors in the main graph;
selecting a final neighborhood set from the lists; and
storing the final neighborhood set in the main graph.

5. The method of claim 4, wherein selecting the final neighborhood set comprises:
evaluating proximity relationships between vertices;
determining optimal neighbor connections; and
maintaining graph connectivity while optimizing search performance.

6. The method of claim 5, further comprising:
implementing the merge operation in parallel across the plurality of proximus nodes;
coordinating the parallel merge operations through the coordinator node; and
maintaining consistency of the main graph during parallel processing.

7. The method of claim 6, further comprising:
periodically initiating a background process;
inspecting vertices of the main graph;
generating optimal neighborhood lists; and
optimizing the main graph structure while maintaining search functionality.

8. The method of claim 7, wherein the update request comprises a plurality of vector insertions, a plurality of vector deletions, and a plurality of vector modifications.

9. The method of claim 8 further comprising:
persisting the batch graph to a distributed database;
queuing the batch graph for processing; and
maintaining batch graph availability during the merge operation.

10. The method of claim 9, wherein making the merged updates available comprises:
validating the merged graph structure;
ensuring search quality meets predetermined thresholds;
updating search indices; and
enabling query access to the updated main graph.

11. A system for parallel processing of updates to a proximity graph, comprising:
a distributed database;
a plurality of proximus nodes, each comprising a processor and memory, configured to maintain independent local batches of updates;
a coordinator node configured to orchestrate merge operations; and
a merging subsystem configured to implement parallel merge operations across the plurality of proximus nodes.

12. The system of claim 11, wherein each proximus node further comprises storage components configured to create and maintain separate Hierarchical Navigable Small World (HNSW) indices.

13. The system of claim 12, wherein the coordinator node comprises scheduling components configured to determine timing and sequence of batch merge operations.

14. The system of claim 13, wherein the merging subsystem comprises neighbor list management modules configured to obtain existing neighbors from subgraphs and create lists of potential new neighbors in a main graph.

15. The system of claim 14, further comprising a background optimization subsystem configured to continuously inspect main graph vertices and generate optimal neighborhood lists.

16. The system of claim 15, wherein the distributed database comprises data persistence mechanisms configured to store batch graphs and provide recovery capabilities.

17. The system of claim 16, further comprising a networking subsystem configured to implement distribution strategies for routing updates across the plurality of proximus nodes.

18. The system of claim 17, further comprising monitoring components configured to validate merged graphs and verify search quality.

19. The system of claim 18, wherein each proximus node is configured to create local batch graphs independently and in parallel with other proximus nodes.

20. The system of claim 19, further comprising interface components configured to make merged updates available for querying through vector database interfaces.
